(19) United States
(12) Patent Application Publication
(10) Pub. No.: US 2015/0314886 A1
(43) Pub. Date: Nov. 5, 2015

(54) LEVERAGE ACTIVATED AIRCRAFT TOW BAR

(71) Applicant: Nicholas R. Guida, Sandpoint, ID (US)

(72) Inventor: Nicholas R. Guida, Sandpoint, ID (US)

(21) Appl. No.: 14/566,463

(22) Filed: Dec. 10, 2014

Related U.S. Application Data
(60) Provisional application No. 61/891,039, filed on Oct. 15, 2013.

(51) Int. Cl. B64F 1/22

(52) U.S. Cl. CPC B64F 1/224

(57) ABSTRACT

An aircraft leverage activated tow bar enables a user to push or pull the aircraft. The tow bar includes an arm member with a handle and a yoke detachably coupled to an aircraft nose gear, a leg member with a first end pivotably mounted to the arm member, and a base unit mounted to a second end of the leg member. The leg member is adjusted to enable the base unit to rest on a ground surface proximate the yoke, thereby allowing a downward force applied to the handle to translate to a corresponding force exerted on the nose gear sufficient to pull the aircraft. The leg member is adjusted to enable the base unit to rest on the ground surface distant to the yoke, thereby allowing a downward force applied to the handle to translate to a corresponding force exerted on the nose gear sufficient to push the aircraft.

### RELATED APPLICATION

The application claims priority to provisional patent application U.S. Ser. No. 61/891,039 filed on Oct. 15, 2013, the entire contents of which is herein incorporated by reference.

### BACKGROUND

The embodiments herein relate generally to aircraft tow bars. More specifically, embodiments of the invention relate to a tow bar for use with general aviation or business aircraft that can weigh up to, or even exceed, 20,000 lbs.

Tow bars are connected to aircraft nose wheels to help push, pull, and/or steer aircraft during ground handling operations. Typically, the tow bar is used to move an aircraft away from a gate or loading area to prepare the aircraft for a departure, relocate an aircraft into or out of a hangar, rotate an aircraft for starting into the wind and for other reasons. There exist a variety of portable and cost-effective aircraft tow bars that require a user to directly push or pull the aircraft using his/her own strength. However, these tow bars are ineffective and/or difficult to use on slippery ground surfaces, inclined ground surfaces, when the operator is of limited physical size or strength, or when used with heavy aircraft. Motorized tow bars or tugs exist, but these devices are heavy, expensive to operate and maintain, and difficult to transport, thereby making them impractical for many situations. In certain circumstances, a pilot may wish to push back an aircraft without a motorized tow bar or tug when a tug operator is unavailable.

As such, there is a need in the industry for an improved leverage activated aircraft tow bar, which allows a user to transfer his/her weight into lateral motion of the tow bar in order to tow, turn or push the aircraft. There is a further need for a leverage activated tow bar that can effectively tow an aircraft on different ground conditions such as ice, pavement, gravel, grass and dirt, while being portable and transportable.

### SUMMARY

A leverage activated tow bar for use with an aircraft to enable a user to push or pull the aircraft by exerting a force on the tow bar is provided. The tow bar comprises an arm member comprising a handle on a first end and a yoke on a second end, the yoke configured to detachably couple to an aircraft nose gear, a leg member comprising a first end pivotably mounted to the arm member, and a base unit mounted to a second end of the leg member, wherein the leg member is pivotably adjusted to a first position to enable the base unit to rest on a ground surface proximate the yoke, thereby allowing a downward force applied to the handle to translate to a corresponding force exerted on the nose gear sufficient to pull the aircraft, wherein the leg member is pivotably adjusted to a second position to enable the base unit to rest on the ground surface distant to the yoke, thereby allowing a downward force applied to the handle to translate to a corresponding force exerted on the nose gear sufficient to push the aircraft.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the leverage activated tow bar;

FIG. 2 depicts a side elevation view of certain embodiments of the leverage activated tow bar in use;

FIG. 3 depicts a side elevation view of certain embodiments of the leverage activated tow bar in use; and

FIG. 4 depicts a cross-sectional view of certain embodiments of the leverage activated tow bar taken on line 4-4 of FIG. 1.

### DETAILED DESCRIPTION OF CERTAIN EMBODIMENTS

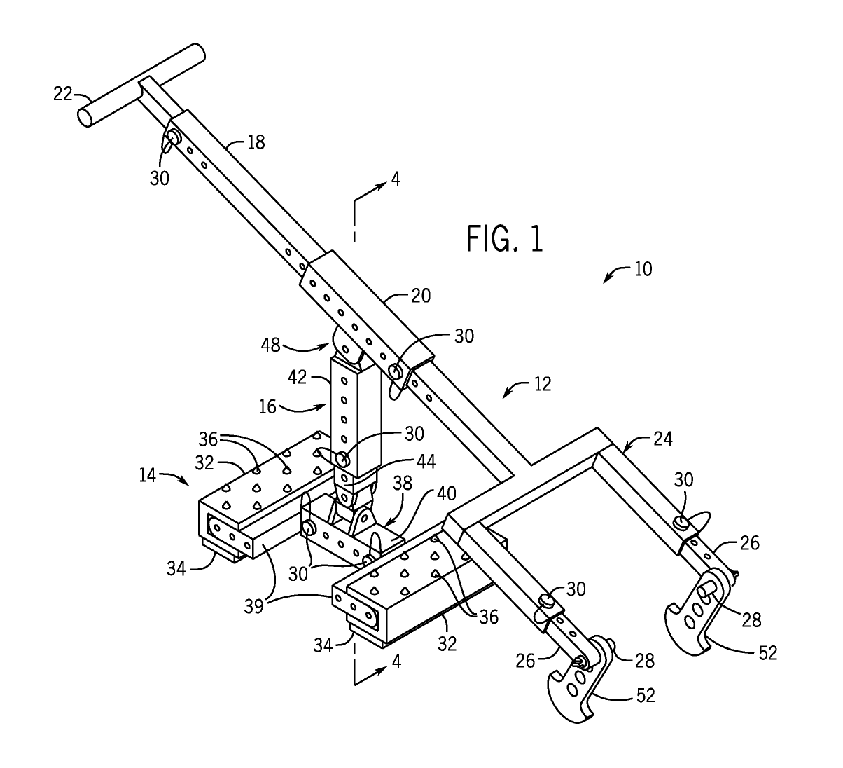

As depicted in FIGS. 1-4, leverage activated tow bar 10 comprises arm member 12, leg member 16 and base unit 14. Arm member 12 comprises handle frame 18 that is slidably mounted to handle 22 and secured to one of a plurality of locking positions by locking pin 30. Arm member 12 further comprises yoke 24 operably connected to sliding yoke members 26. Sliding yoke members 26 can be slidably adjusted relative to yoke 24 to one of a plurality of locking positions by locking pins 30. A first brake member 52 is rotatably mounted to a first prong of yoke 24 by a first sliding yoke member 26. A second brake member 52 is rotatably mounted to a second prong of yoke 24 by a second sliding yoke member 26. Brake members 52 are rotatably mounted to sliding yoke members 26 by axle spring pins 28. In an alternative embodiment, each brake member 52 comprises a pair of telescoping members (not shown) to enable the longitudinal length of the brake member to be adjustable. In a preferred embodiment, arm member 12 is approximately 6-7 feet long when handle frame 18 and handle 22 are in the fully extended position and approximately 3 feet long when handle frame 18 and handle 22 are in the fully compressed position.

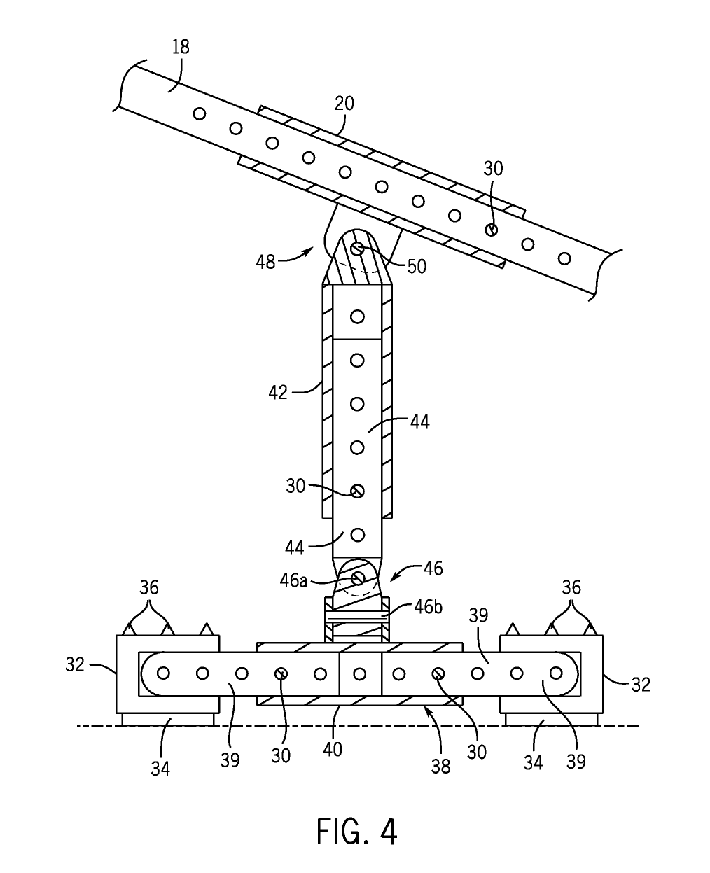

Sleeve 20 is slidably mounted to handle frame 18 and can be adjusted to one of a plurality of locking positions by locking pin 30. Leg member 16 comprises inner leg member 44 slidably mounted to outer leg member 42 by locking pin 30. A first end of leg member 16 is pivotably mounted to sleeve 20 of arm member 12 by knee joint 48 and pivot 50. A detent is operably connected to the first end of leg member 16 to provide sufficient friction to enable leg member 16 to remain in a temporary and limited desired angled position when pivotably adjusted. A second end of leg member 16 is pivotably mounted to base unit 14 by ankle joint 46. In FIG. 4, ankle joint 46 is shown in more detail, which further comprises upper pivot 46a and lower pivot 46b Inner leg member 44 slidably adjusts relative to outer leg member 42 to one of a plurality of locking positions. In a preferred embodiment, inner leg member 44 and outer leg member 42 are approximately 6 inches in height in the fully compressed position and 12 inches in height in the fully extended position. However, it shall be appreciated that the size of the components can be varied to permit alternate height adjustments.

Base unit 14 comprises foot cross unit 38, adjustable members 39, sleeve 40, and a pair of reversible multiple-terrain footpads 32. However, it shall be appreciated that any alternative number of multiple-terrain footpads 32 can be used instead. Sleeve 40 is slidably adjusted to adjustable members 39 and secured in place by locking pins 30. Each reversible multiple-terrain footpad 32 comprises rubber pad 34 and spikes 36. Each reversible multiple-terrain footpad 32 is operably connected to cross unit 38 by an adjustable fastening component such as a swivel. This permits reversible multiple-terrain footpads 32 to be adjusted such that either rubber pads 34 or spikes 36 are in contact with the ground surface. Typically, rubber pads 34 are configured for use with surfaces such as asphalt or concrete. Spikes 36 are configured for use with slippery surfaces such as ice, dirt, grass, loose gravel, or the like. It shall be appreciated that alternative abrasive surfaces may be used to enhance the traction of reversible multiple-terrain footpads 32 such as “diamond plate” or coarse sandpaper type surfaces.

In an alternative embodiment, leverage activated tow bar 10 can be simplified to single non-adjustable components to simplify the manufacturing process and reduce costs. For example, arm member 12 can be a single component combining handle 22, handle frame 18 and yoke 24. Similarly, leg member 16 and base unit 14 can be combined to a single non-adjustable component.

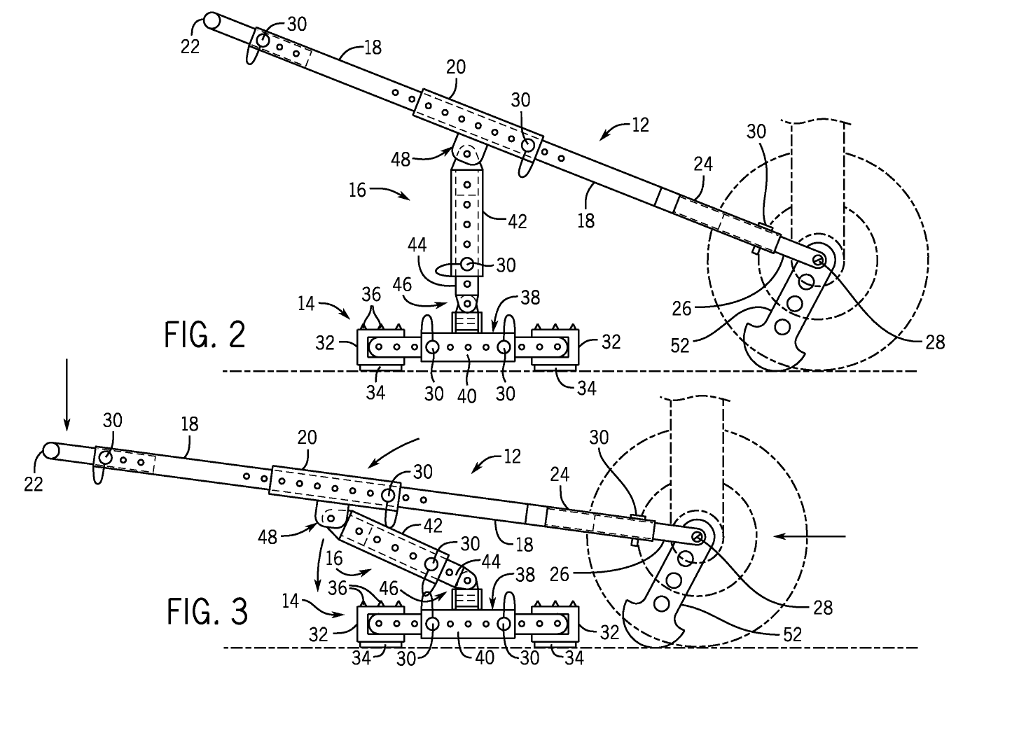

As depicted in FIG. 2, an operator secures yoke 24 onto an aircraft nose wheel assembly by using axle spring pins 28 to lock yoke 24 to the aircraft nose wheel axle. It shall be appreciated that any alternative known fastening components in the field can be used to secure yoke 24 to the aircraft nose wheel assembly such as hooks and loops, male and female snap components, or the like. The components of leverage activated tow bar 10 are adjusted to accommodate the operator, aircraft and ground conditions. Specifically, handle frame 18 and handle 22 are slidably adjusted to a desired position, sleeve 20 and handle frame 18 are slidably adjusted to position leg member 16 in a desired position, and sliding yoke members 26 and yoke 24 are slidably adjusted to a desired position. Multiple-terrain footpads 32 are adjusted such that either rubber pads 34 or spikes 36 are in contact with the ground surface to achieve the desired level of traction. This enables base unit 14 to have the required friction to allow the operator to tow the aircraft in all ground conditions such as ice, pavement, gravel, grass and dirt.

To pull or move the aircraft, handle 22 is lifted and multiple-terrain footpads 32 of leg member 16 are pivotably adjusted towards the nose wheel assembly to enable base unit 14 to rest on the ground surface proximate yoke 24 as depicted in FIG. 3. This positions the longitudinal axis of leg member 16 so it is not perpendicular to the ground surface, with footpads 32 aft of the leg pivot point. Brake members 52 are rotated clockwise (not shown) to point away from handle 22 and rest on the ground surface. This enables brake members 52 to drag along the ground as the aircraft is being pulled forward, and prevents the aircraft from rolling backwards. The operator applies a downward force on handle 22. Leg member 16 and base unit 14 provide a high mechanical advantage to the handle down force that translates to a corresponding lateral force exerted on the aircraft nose wheel sufficient to pull the aircraft forward.

As the aircraft begins to move, the operator can continue a pumping action of lifting handle 22 up and pushing down on handle 22 to continue the acceleration of the aircraft as needed. Leg member 16 acts as a ratchet on the ground surface. This pumping action provides additional forces on the aircraft nose wheel axle until the operator can pull the aircraft without the need for additional pumping. If the operator engages in a larger pumping action such as lifting handle 22 an amount sufficient to lift base unit 14 off the ground surface, the detent enables leg member 16 to maintain its angled position with base unit 14 proximate yoke 24. Once the operator pushes down on handle 22, base unit 14 is in the proper position to contact the ground surface and enable a transfer of the subsequent down handle force to a corresponding force exerted on the nose wheel assembly. If the operator engages in a smaller pumping action where lifting handle 22 results in base unit 14 remaining in contact with the ground surface, multiple-terrain footpads 32 will drag along the ground surface as the aircraft moves and a subsequent downward force is applied to handle 22. It shall be appreciated that the aircraft can be steered and turned when the operator applies a sideward force on handle 22 in conjunction with the accompanying applied downward force. This resultant force will provide steerage and motive forces at the wheel axle of the aircraft. Once the aircraft is towed to a desired position, brake members 52 can be adjusted to prevent the aircraft from moving, i.e., one brake member 52 oriented forward and in contact with the ground and one brake member 52 oriented backward and in contact with the ground.

Alternatively, to push the aircraft, handle 22 is lifted and leg member 16 is pivotably adjusted away from the nose wheel assembly to enable base unit 14 to rest on the ground surface distant to yoke 24 (not shown). This positions the longitudinal axis of leg member 16 so it is not perpendicular to the ground surface, with the footpad 32 forward of the leg pivot point. Brake members 52 are rotated to point towards handle 22 and rest on the ground surface. This enables brake members 52 to drag along the ground as the aircraft is being pushed backward. The operator applies a downward force on handle 22. Leg member 16 and base unit 14 provide a high mechanical advantage to the handle down force that translates to a corresponding lateral force exerted on the aircraft nose wheel sufficient to push the aircraft backward. The operator continues the pumping action described above to steer the plane to a desired position.

It shall be appreciated that components of leverage activated tow bar 10 described in several embodiments herein may comprise any known materials in the field including, but not limited to, steel, aluminum, bamboo, wood, titanium, or the like, and be of any color, size and/or dimensions. This allows the tow bar to accommodate any variety of aircraft and operators. It shall be appreciated that components of the leverage activated tow bar 10 described herein may be manufactured and assembled using any known techniques in the field. It shall be appreciated that the tow bar described herein may be modified to tow other vehicles including, but not limited to, cars, heavy machinery, boats on trailers, or the like.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A leverage activated tow bar for use with an aircraft to enable a user to push or pull the aircraft by exerting a force on the tow bar, the tow bar comprising:
an arm member comprising a handle on a first end and a yoke on a second end, the yoke configured to detachably couple to an aircraft nose gear;
a leg member comprising a first end pivotably mounted to the arm member; and
a base unit mounted to a second end of the leg member;
wherein the leg member is pivotably adjusted to a first position to enable the base unit to rest on a ground surface proximate the yoke, thereby allowing a downward force applied to the handle to translate to a corresponding force exerted on the nose gear sufficient to pull the aircraft, wherein the leg member is pivotably adjusted to a second position to enable the base unit to rest on the ground surface distant to the yoke, thereby allowing a downward force applied to the handle to translate to a corresponding force exerted on the nose gear sufficient to push the aircraft.

2. The leverage activated tow bar of claim 1, further comprising a detent operably connected to the first end of the leg member to enable the leg member to remain in the adjusted first position or second position.

3. The leverage activated tow bar of claim 2, further comprising a first brake member rotatably mounted to a first prong of the yoke and a second brake member rotatably mounted to a second prong of the yoke.

4. The leverage activated tow bar of claim 3, wherein the base unit comprises a first foot pad and a second footpad, wherein the first and second footpads are configured to contact the ground surface.

5. The leverage activated tow bar of claim 4, wherein each footpad comprises a first rubberized side and a second side comprising spikes, wherein each footpad is configured to be adjusted such that the first side or second side contacts the ground surface.

6. The leverage activated tow bar of claim 5, wherein the handle is slidably mounted to the arm member, wherein the handle is configured to slidably adjust relative to the arm member to one of a plurality of locking positions.

7. The leverage activated tow bar of claim 6, wherein the leg member comprises an inner leg member slidably mounted to an outer leg member, wherein the inner leg member slidably adjusts relative to the outer leg member to one of a plurality of locking positions.

8. The leverage activated tow bar of claim 7, further comprising a sleeve slidably mounted to the arm member, wherein the sleeve slidably adjusts relative to the arm member to one of a plurality of locking positions.

9. The leverage activated tow bar of claim 8, wherein the first end of the leg member is pivotably mounted to the sleeve.
